(19) United States
(12) Patent Application Publication
(10) Pub. No.: US 2019/0174225 A1
(43) Pub. Date: Jun. 6, 2019

(54) LOUDSPEAKER

(71) Applicant: ZINGALI ACOUSTICS SPA, Aprilia (IT)

(72) Inventor: Giuseppe ZINGALI, Aprilia (IT)

(21) Appl. No.: 16/306,010

(22) PCT Filed: Jun. 7, 2017
(86) PCT No.: PCT/IB2017/053343

§ 371 Date: Nov. 30, 2018

(30) Foreign Application Priority Data
Jun. 7, 2016 (IT) 102016000058096

(51) Int. Cl. H04R 1/30; H04R 1/34; H04R 1/28; H04R 1/02; H04R 9/06

(52) U.S. Cl. CPC H04R 1/30; H04R 1/345; H04R 1/025; H04R 1/023; H04R 9/063; H04R 1/2819

(57) ABSTRACT

Loudspeaker (1) comprising:—a container (2) provided with a front opening (3) delimited by at least two opposite edges (4, 5) of the container (2);—at least a first and a second speaker (30, 31) housed in the container (2);—a mounting panel (20) to which are fixed the first and the second speaker; characterised in that:—the container (1) comprises two front walls (10, 11) disposed on opposite sides respect to the front opening (3), wherein the front walls (10, 11) define an acoustic waveguide diverging between an inlet throat and an outlet mouth and wherein the front opening of the container (3) is the inlet throat of the diverging acoustic waveguide;—the diverging acoustic waveguide is a guide common to the first and second speaker; characterised in that:—the first speaker (30) is, or comprises, a woofer or a midwoofer;—the second speaker (31) is, or comprises, a dome tweeter or a compression driver.

### FIELD OF THE INVENTION

The present invention relates to the field of sound reproduction systems and in particular it relates to a loudspeaker.

### PRIOR ART

A loudspeaker is a compact sound system that contains one or more acoustic transducers, or speakers, adapted to convert an electrical audio signal into a sound. The prior art loudspeakers generally include a container, called box or cabinet, and one or more speakers attached to the container.

In a loudspeaker, the role of the container is to prevent the sound waves coming from the back of a speaker from interfering destructively with those emitted from the front part of the speaker. The sound waves emitted from the back are in fact out of phase by 180° compared to those emitted from the front, therefore without a container these waves typically cause cancellations that significantly degrade the level and quality of sound at low frequencies.

Generally, the container of a loudspeaker is a closed box-like container and is provided on a front wall, called baffle, with one or more mounting openings that allow attaching the speakers to the container.

If, as almost always happens, loudspeakers comprise multiple speakers of different type, such as a speaker for high frequencies (for example comprising a dome tweeter or a compression driver) and a speaker for the low or low and medium frequencies (such as a woofer or a midwoofer), mounting the speakers to the container does not allow aligning the acoustic centres of the speakers. This results in a time delay between the acoustic radiation emitted by the speakers and therefore different arrival times. This is a problem from a performance point of view, so if one wants to keep a desired level of performance it is necessary to carry out some corrections on the electric signals that feed the speakers.

The object of the present description is to provide a loudspeaker that allows solving, or at least partly reducing, the drawbacks described above with reference to the loudspeakers of the prior art described above.

This object is achieved by a loudspeaker as generally defined in claim 1. Preferred and advantageous embodiments of the above loudspeaker are defined in the dependent claims.

The invention will be better understood from the following detailed description of a particular embodiment thereof, made by way of an example and therefore in no way limiting, with reference to the accompanying drawings briefly described in the following paragraph.

### BRIEF DESCRIPTION OF THE DRAWINGS

FIG. 1 shows a plan front elevation view of a first non-limiting embodiment of a loudspeaker, wherein the loudspeaker comprises a container and a mounting panel to which a plurality of speakers are attached.

FIG. 2 is a perspective top angle view of the loudspeaker in FIG. 1 from which the mounting panel and therefore also the speakers attached thereto have been removed.

FIG. 3 shows a plan lateral sectional view of part of the loudspeaker shown in FIG. 1, where the section plane is denoted by B-B in FIG. 1.

FIG. 4 shows a plan view of a part of the loudspeaker in FIG. 1.

FIG. 5 shows a perspective view of a part of the loudspeaker in FIG. 1.

FIG. 6 shows a plan sectional view of a part of the loudspeaker in FIG. 1.

FIG. 7 shows a plan sectional view of a part of the loudspeaker in FIG. 1.

FIG. 8 shows a plan front elevation view of a second non-limiting embodiment of a loudspeaker.

FIG. 9 shows a perspective view of a part of the loudspeaker in FIG. 9.

FIG. 10 shows a sectional view of a part of the loudspeaker in FIG. 9.

### DETAILED DESCRIPTION

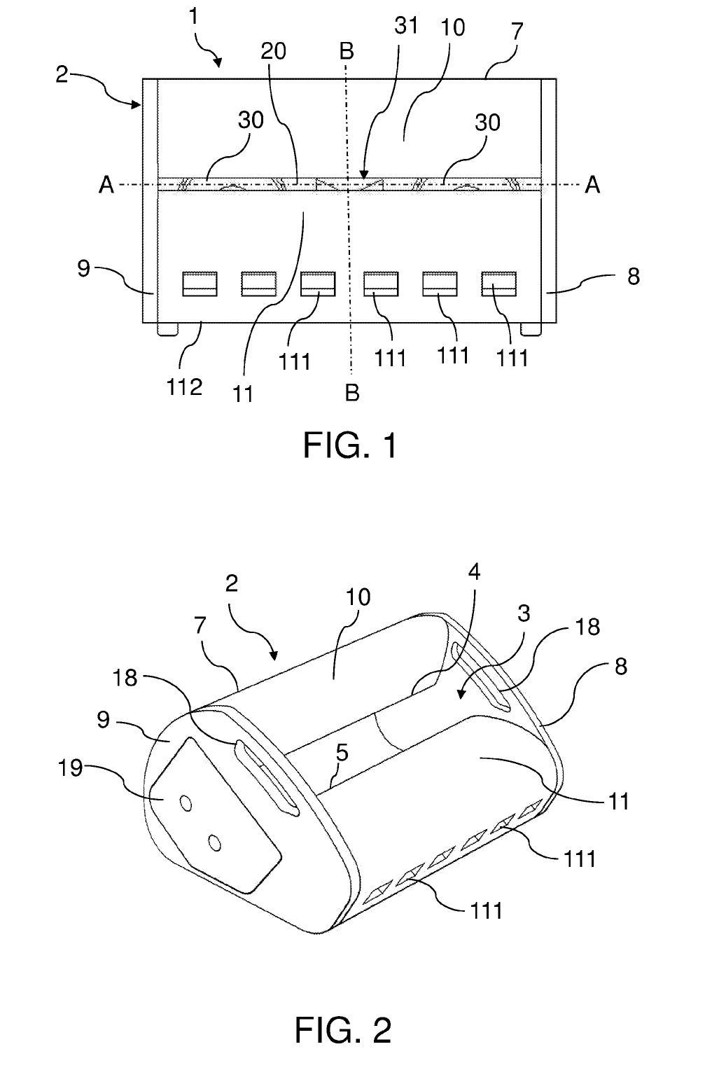

FIG. 1 shows an exemplary non-limiting embodiment of a loudspeaker 1. In the particular embodiment shown, loudspeaker 1 is in particular a monitor loudspeaker, i.e. a loudspeaker intended to be placed on a floor of a stage during a concert or a musical or theatrical show, generally live. As will be explained better in the remainder of the present description, the teachings proposed herein are also applicable to other types of loudspeakers, whereby the scope of protection should not be considered limited to monitor loudspeakers.

Loudspeaker 1 comprises a container 2 provided with a front opening 3 delimited by at least two opposite edges 4, 5 of container 2. In the particular example shown, the front opening 3 that is only partially visible in FIG. 1 while is better visible in FIG. 2 is a quadrangular, preferably rectangular slot. According to an advantageous embodiment from the point of view of acoustic performance, container 2 is preferably made of wood or mostly wood with some parts of other materials, such as plastic or metallic materials. In alternative embodiments, container 2 may be made of a material other than wood, such as a plastic or metal, or any other material appropriate to the use. For example, container 2 can be made of aluminum, ABS or fiberglass.

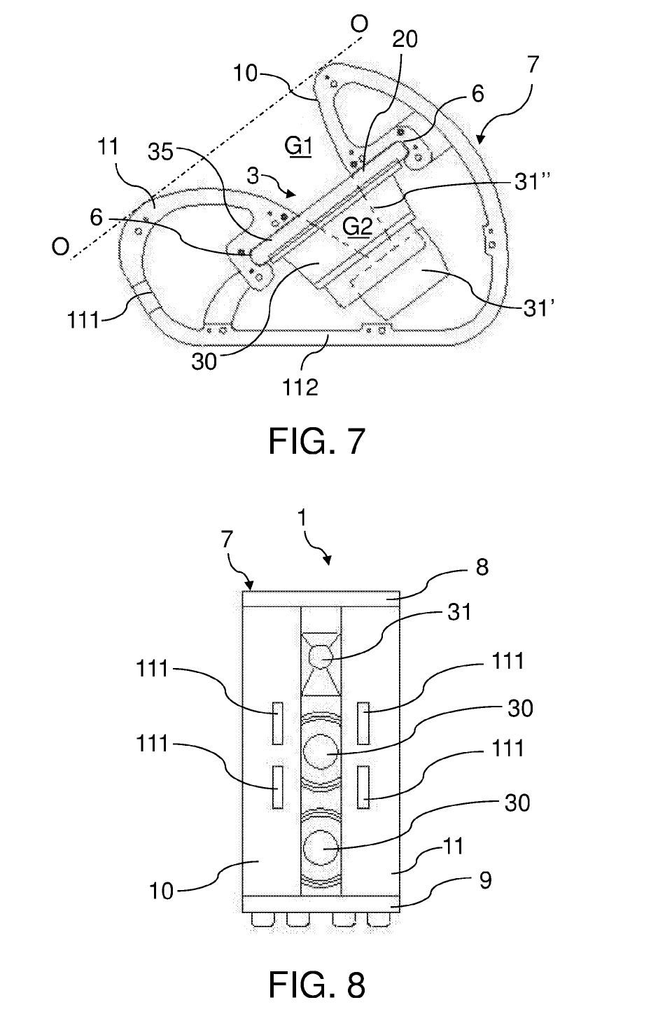

Loudspeaker 1 further comprises at least a first speaker 30, 31 and at least a second speaker 31 accommodated into container 2. The first speaker 30 is, or comprises, a woofer or a midwoofer and the second speaker 31 is, or comprises, a dome tweeter or a compression driver. In the particular non-limiting example shown in FIG. 1, loudspeaker 1 comprises three speakers 30, 31, according to a configuration that a man skilled in the art calls D'Appolito configuration. This configuration is also known as MTM (acronym of midwoofer-tweeter-midwoofer). In this configuration, a tweeter (i.e. a speaker for high frequencies, meaning for example both a compression driver and a dome tweeter) is interposed between two woofers (i.e. 2 speakers for low frequencies), or between two mid-ranges (i.e. two speakers for midrange frequencies) or between two mid-woofers (i.e. speakers for medium and low frequencies). For the purposes of the present description, high frequency speaker, medium frequency speaker, low frequency speaker, and medium-low frequency speaker are expressions that involve well known features to a man skilled in the art which do not require additional details about the specific frequency ranges of interest. Loudspeaker 1 further comprises a mounting panel 20 to which the first and the second speaker 30, 31 are fixed. The mounting panel 20 is a baffle of loudspeaker 1. Preferably, the mounting panel 20 acts as a support element for the first and second speaker 30, 31. Advantageously, the first and the second speaker 30, 31 are fixed inside container 2 behind the mounting panel 20. In other words, the first and the second speaker 30, 31 are closed in the container 2 behind the front opening 3 of container 2. In the particular non-limiting example shown in FIG. 1, to the mounting panel 20 are attached two woofer or mid-woofer speakers 30 between which a high frequency speaker 31 is interposed, preferably meaning a compression driver or a dome tweeter. Conveniently, the mounting panel 20 includes for each speaker 30, 31 a respective through opening 23, 21. In the particular example shown in FIGS. 1-7, the mounting panel comprises three through openings 21, 23. Preferably, the through openings 23 for the two woofer or midwoofer speakers 30 are smaller than the size of the membranes of such speakers 30. This also applies in the case where only one woofer or midwoofer speaker 31 is provided in addition to the second speaker 31.

According to an advantageous embodiment, container 2 of speaker 1 comprises a fixing guide with a guide axis A-A. Preferably, the first and second speaker 30, 31 are arranged axially spaced along the guide axis A-A. In the above advantageous and non-limiting embodiment, the mounting panel 20 is a slide slidably received in the fixing guide to close the front opening 3.

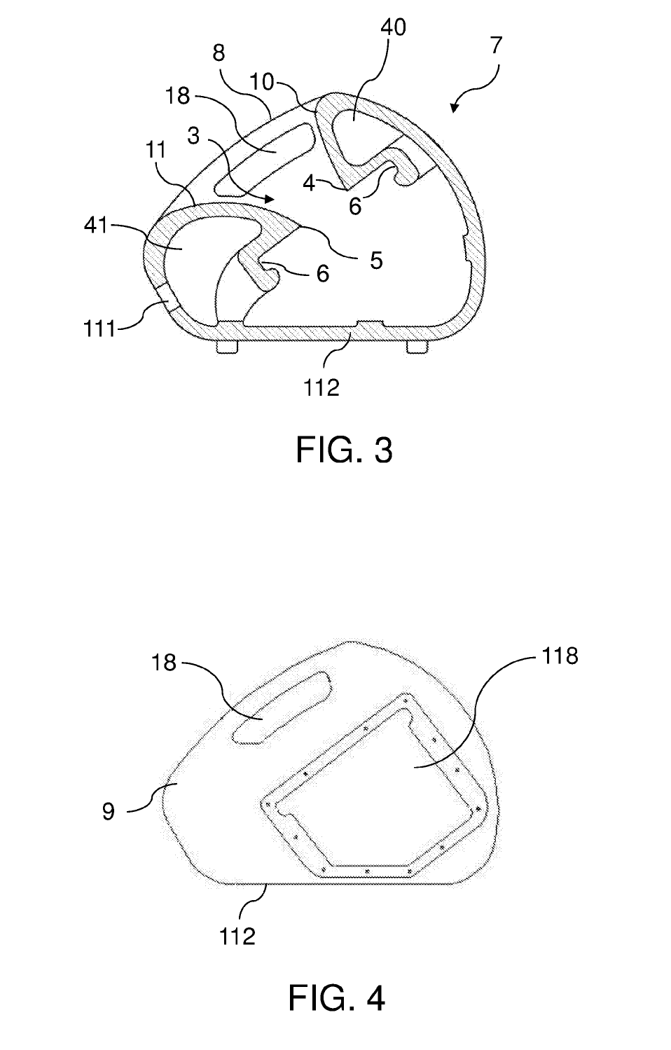

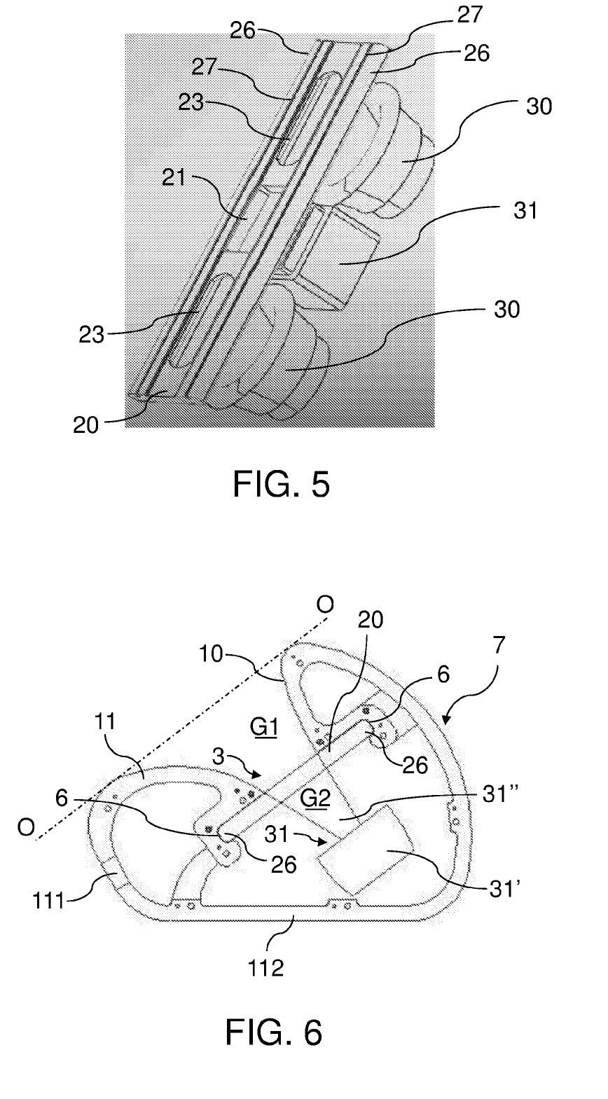

With reference to FIGS. 3 and 5 in loudspeaker 1, the fixing guide comprises two opposite fixing channels 6 parallel to the guide axis A-A. Two end portions 26 of the mounting panel 20 are each inserted in a respective fixing channel 6. Preferably, the end portions 26 have a peripheral edge that in a transverse plane to the axis A-A is rounded.

According to an advantageous embodiment, the fixing guide is integrated into the walls of container 2. In the particular example shown, this is achieved thanks to the fact that the fixing channels 26 are recesses made in the walls of container 2, preferably arranged opposite to each other with respect to the front opening 3 into container 2.

According to a particularly advantageous embodiment from the point of view of the assembly operations, container 2 comprises a central body 7 at least partly hollow and two side walls 8, 9 mutually arranged at opposite sides with respect to the central body 7 and at least one of the side walls 8, 9 comprises an opening 118 transverse to the guide axis A-A. The assembly made up by the mounting panel 20 and the at least one speaker 30, 31 is extractable through the transverse opening 118 by sliding the mounting panel 20 with respect to the central body 7 along the guide axis A-A. In this way, the mounting panel 20 can be slidably inserted into container 1 by crossing one of the two side walls 8, 9 to be fixed to container 1 and/or to be then slidably extracted during inspection and/or maintenance operations. Preferably, in the above embodiment, loudspeaker 1 comprises at least one closing device 19 fixed to the side wall 9 which comprises the transverse opening 118 for closing said transverse opening and preventing a sliding of the mounting panel 20 along the guide axis A-A, thereby locking the position of the mounting panel 20 with respect to the central body 7. The closing device 19 for example is a plastic or metal plate. Preferably, loudspeaker 1 comprises removable fasteners, such as at least one screw and at least one respective hole, adapted to removably fix the closing device 19 to the side wall 9.

The foregoing can optionally be applied also to the side wall 8.

According to a preferred embodiment, the side walls 8, 9 are flat walls. Preferably, at least one of the side walls 8, 9 comprises a blind or through recess 18. Such a recess 18 may be shaped as an ergonomic hand gripping element and in the specific example shown is a through recess with a curved slot shape.

According to an advantageous embodiment, the mutually opposite edges delimiting the front opening 3 extend each by a length equal to the distance between the side walls 8, 9. In other words, in this embodiment, the front opening 3 is laterally delimited by said side walls 8, 9.

According to an advantageous embodiment, the mounting panel 20 comprises a protective screen, such as a grid, not shown in the figures, fixed to the mounting panel 20. Preferably, the above grid is a metal grid and is covered by a waterproof and acoustically transparent foam. For example, this protective screen has a flat central part and two side edges folded, for example perpendicular to the central part. By suitably providing two mutually parallel recesses 27 in the mounting panel 20 it is possible to couple the protective screen to the mounting panel 20 and then insert the assembly thus formed in container 2 by sliding the opposite edges 26 of the panel into the fixing guide, i.e. in the fixing channels 6.

According to a preferred embodiment, container 2, and preferably the central body 7 of container 2, includes a plurality of monobloc portions mutally aligned along the guide axis A-A and juxtaposed and fixed, for example through fasteners that cross them along a direction parallel to the guide axis A-A. The fixing between the monobloc portions can be achieved through pins that cross through openings crossing the monobloc portions. The end portions of the pins can be threaded so as to tighten the monobloc portions by means of nuts screwed to the threads (if the threads of the pins are external) or screws screwed into the threads (if the threads of the pins are internal). The monobloc portions for example are made of wood with carving operations, starting from a piece of solid wood, such as with a pantograph. For example, the monobloc portions are made through a processing technique called empty for full. Alternatively, for example if made of plastic or metal, the monobloc portions may be made by moulding.

Container 2, preferably the central body 7, comprises two front walls 10, 11 arranged on opposite sides with respect to the front opening 3. The front walls 10, 11 define an acoustic waveguide G1 diverging between an inlet throat and an outlet mouth and the front opening 1 of container 3 represents the inlet throat of the acoustic waveguide G1. In FIG. 6, the dashed axis O-O indicates the lying plane of the outlet mouth of the acoustic waveguide G1. This advantageously allows fixing tweeter 31 for example to the mounting panel 20 (meaning for example either a compression driver or a dome tweeter) and a woofer 30 or a mid-woofer 30, each facing a respective opening 21, 23 so as to obtain that the acoustic waves emitted by the two sources 30, 31, that is, by the speakers 30, 31 are at the outlet of loudspeaker 1 in a time alignment relation.

According to a particularly advantageous embodiment, the front walls 10, 11 are two curved walls. Preferably, the front walls 10, 11 outwards of container 2 are convex. More preferably, the front walls 10, 11 inwards of container 2 are concave. In other words, each of front walls 10, 11 defines one or more respective cavities, or recesses, 40, 41 inside container 2.

According to a preferred and non-limiting embodiment, at least one of the front walls 10, 11, in the example of FIGS. 1-7 the front wall 11, comprises at least one bass reflex through opening 11 adapted to allow a fluidic communication between the inside and the outside of container 2. Preferably, the above bass reflex opening 111 is quadrangular, for example rectangular. Preferably, the above at least one front wall 11 comprises an array of bass reflex through openings 111 extending along a direction parallel to said guide axis A-A. It should be noted that in the exemplary non-limiting embodiment of FIGS. 1-7 there is an array of six bass reflex through openings 111 on the front wall 11.

In the embodiment in FIGS. 1-7, loudspeaker 1 is a monitor loudspeaker and the front walls 10, 11 have mutually different shapes. One of the front walls, in particular the front wall 11, is joined to a flat wall 112 of the central body 7 that serves as a support base for loudspeaker 1.

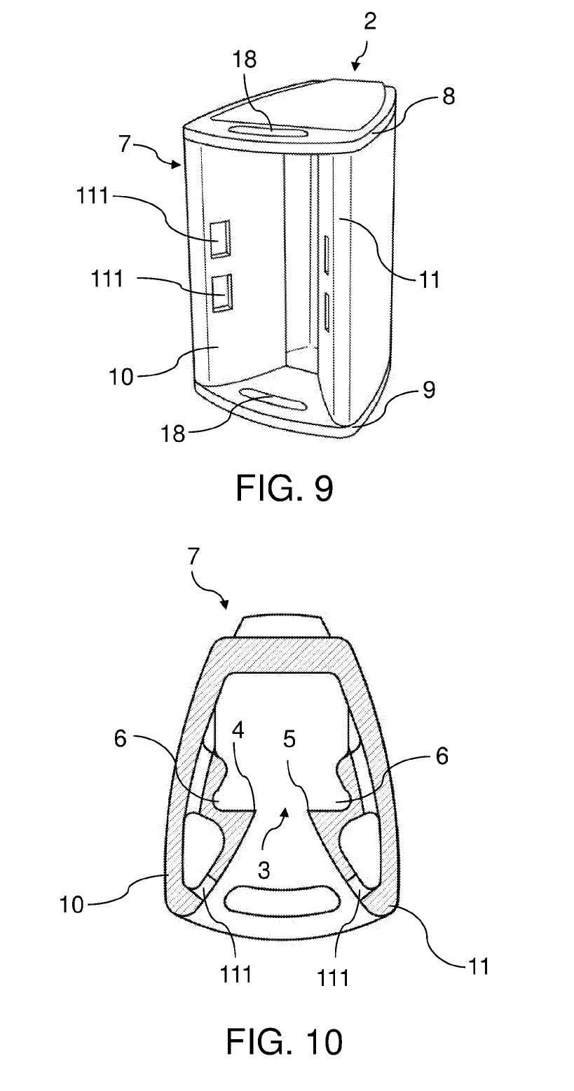

In an alternative embodiment to that described above and for example shown in FIGS. 9-10, the front walls 10, 11 have mutually equal or substantially equal shape.

According to a particularly advantageous embodiment, loudspeaker 1 comprises a least one speaker 30, 31 comprising a compression driver 31′ or a dome tweeter 31′ and a horn 31″ housed within container 2. Horn 31″ has an inlet throat adapted to receive an acoustic radiation emitted by the compression driver 31′ or the dome tweeter 31′ and an outlet mouth opposite the inlet throat. Horn 31″ is fixed to the mounting panel 20. As a whole, the compression driver 31 or dome tweeter 31 and horn 31″ constitute a tweeter of loudspeaker 1, i.e. a speaker for high frequencies. Advantageously, the outlet mouth of horn 31″ is aligned with the inlet throat of the diverging acoustic waveguide G1 of container 2. Preferably, the outlet mouth of horn 31″ has a width equal to the distance between the opposite edges 4, 5 of container 2.

According to a particularly advantageous embodiment, horn 31″ has two inner walls mutually opposite and diverging and joined with continuity each to a respective front wall 10, 11 to form a single acoustic waveguide G2, G1 extending from the inlet throat of horn 31″ along the acoustic guide G2 defined by the same horn 31″ to the outlet mouth of the acoustic waveguide G1 of container 2. Preferably, such a single acoustic waveguide G2, G1 has a cross-section continuously diverging along transverse planes, particularly perpendicular, to the front walls 10, 11, such as shown in FIG. 6.

As explained above, the teachings described herein are not limited to a monitor type loudspeaker 1. With reference to FIGS. 8-10, a second non-limiting embodiment is shown wherein loudspeaker 1 has a column container 2. Loudspeaker 1 in FIGS. 8-10 differs from loudspeaker 1 described with reference to FIGS. 1-7 primarily in that the front walls 10, 11 of container 2 are mutually equal, in the provision of two arrays of bass reflex openings 111 and in a different arrangement of speakers 30, 31. Moreover, embodiments were also shown with three speakers, but there is no constraint on the number of speakers, which can be from a minimum of two up to a large integer. Moreover, single loudspeakers have also been shown and described intended are to be placed on a surface, but clearly it is also possible to implement suspended modular systems of the line-array type in which multiple loudspeakers of the type described above are stacked on top of each other.

From the foregoing it is clear that a loudspeaker of the type described above allows fully achieving the objects set out in terms of overcoming the drawbacks of the prior art.

The principle of the invention being understood, the manufacturing details and the embodiments may widely vary compared to what described and illustrated by way of a non-limiting example only, without departing from the scope of the invention as defined in the accompanying claims.

1. A loudspeaker comprising:
a container provided with a front opening delimited by at least two opposite edges of the container;
at least a first and a second speaker housed in the container;
a mounting panel to which are fixed the first and the second speaker;
wherein:
the container comprises two front walls disposed on opposite sides with respect to the front opening, wherein the front walls define an acoustic waveguide diverging between an inlet throat and an outlet mouth and wherein the front opening of the container is the inlet throat of the diverging acoustic waveguide;
the diverging acoustic waveguide is a guide common to the first and second speaker;
characterised in that:
the first speaker comprises a woofer or a midwoofer; and
the second speaker comprises a dome tweeter or a compression driver.

2. The loudspeaker according to claim 1, wherein the front walls are two curved walls.

3. The loudspeaker according to claim 2, wherein the front walls are convex towards the outside of the container and are concave towards the inside of the container.

4. The loudspeaker according to claim 1, wherein the container comprises a fixing guide having a guide axis and the mounting panel is a slide slidably received in the fixing guide to close the front opening.

5. The loudspeaker according to claim 4, wherein the fixing guide comprises two opposite fixing channels parallel to the guide axis and wherein two opposite portions of the mounting panel are each inserted in a respective fixing channel.

6. The loudspeaker according to claim 4, wherein:
the container comprises a central body, hollow at least in part, and two side walls disposed on opposite sides with respect to the central body;
at least one of the side walls comprises an opening transverse to the guide axis; and
the assembly made up by the mounting panel and by said speakers is removable through said transverse opening by sliding the mounting panel with respect to the central body along the guide axis.

7. The loudspeaker according to claim 6, wherein the side walls are flat.

8. The loudspeaker according to claim 7, further comprising at least one closing device fixed to said at least one side wall to close said transverse opening and prevent a sliding of the mounting panel along the guide axis by locking the position of the mounting panel with respect to the central body.

9. The loudspeaker according to claim 1, wherein at least one of the front walls comprises at least one bass reflex through opening adapted to allow a fluidic communication between the inside and the outside of the container.

10. The loudspeaker according to claim 9, wherein said at least one front wall comprises an array of bass reflex through openings that extends along a direction parallel to said guide axis.

11. The loudspeaker according to claim 1, wherein the front walls have shapes identical to each other.

12. The loudspeaker according to claim 1, wherein said loudspeaker is a monitor speaker and the front walls have different shapes from each other and wherein one of the front walls is joined to a flat wall of the central body which acts as a support base of the loudspeaker.

13. The loudspeaker according to claim 1, wherein the central body of the container includes a plurality of monoblock portions aligned with each other along the guide axis and juxtaposed and fixed among them.

14. The loudspeaker according to claim 1, wherein the second speaker comprises a compression driver or a dome tweeter and a horn housed inside the container, wherein the horn has an inlet throat adapted to receive an acoustic radiation emitted by the compression driver or dome tweeter and an outlet mouth opposite the inlet throat, wherein the horn is fixed to the mounting panel.

15. The loudspeaker according to claim 14, wherein the outlet mouth of the horn is aligned with the inlet throat of the diverging acoustic waveguide of the container.

16. The loudspeaker according to claim 14, wherein said outlet mouth has a width equal to the distance between said opposite edges.

17. The loudspeaker according to claim 14, wherein the horn has two inner walls that are each joined with continuity to a respective front wall to form a single acoustic waveguide that extends from the inlet throat of the horn to the outlet mouth of the acoustic waveguide of the container.

18. The loudspeaker according to claim 1, wherein the container is made of wood, plastic, metal material, or fibreglass.

19. The loudspeaker according to claim 1, wherein the first and second speaker are attached to the inside of the container behind the mounting panel.
